(19) United States
(12) Patent Application Publication
(10) Pub. No.: US 2006/0253351 A1
(43) Pub. Date: Nov. 9, 2006

(54) Methods and systems for the management of insurance claims and property

(76) Inventor: Michael William Keaney, Tauranga (NZ)

Correspondence Address: Dr. O. M. (Sam) Zaghmout;Bio IPS, 8509 Kernon Ct., Lorton, VA, 22079, US

(21) Appl. No.: 10/551,807

(22) PCT Filed: Apr. 2, 2004
(86) PCT No.: PCT/NZ04/00065

§ 371 Date: Sep. 30, 2005

(30) Foreign Application Priority Data
Apr. 2, 2003 (NZ) 525159

(51) Int. Cl. G06Q 40/00; G06Q 99/00

(52) U.S. Cl. 705/35; 705/1

(57) ABSTRACT

This invention relates to the management of insurance claims, the processing steps broadly including the steps of obtaining information on a claim, including items of property relating to said claim, such information forming a claim datafile; selecting items of property being claimed by consulting a property register configured and arranged to store items of property owned by the person or entity making a claim; obtaining information to establish a replacement value for each of the items of property relating to the claim; and selecting a method of settlement of the claim and calculating the replacement values for each of the items of property to determine a settlement value.

### TECHNICAL FIELD

This invention relates to methods and systems for managing insurance claims and property.

### BACKGROUND ART

The processing steps of settling an insurance claim has to date generally been a largely manual and labour intensive task. Although various computer software programs have been implemented to assist the task of processing claims, they have generally been ad hoc developments and have only automated a few steps in the process from first handling a claim application to full settlement of the claim. Further, the use of additional consultative electronic databases such as claims histories and property registers have not been considered or used.

A further step in the standard process of settling an insurance claim has been the use and reliance on a paper file. This requires a claims handler to write proper file notes and to record transactions and agreements. Unfortunately this reliance can sometimes be misplaced and claims handlers can either fail to record details making it difficult for other claims handlers to continue work on the file to complete a subsequent step if the previous person has retained information in their memory rather than recorded details.

Further, client histories in paper form can be difficult to access when held in one branch location and a claim making a subsequent claim has moved location and is claiming via a different branch. Standardisation of processing steps can also be difficult to achieve between various offices in an organisation where various business units operate business processes in different ways.

It is one non-limiting object of the invention to provide a method of and system for handling or managing claims that overcomes at least some of the abovementioned problems, or at least to provide the public with a useful choice.

### SUMMARY OF THE INVENTION

According to a first broad aspect of the invention there is provided a method of managing an insurance claim, the method including the steps of:
a) obtaining information on a claim, including items of property relating to said claim, such information forming a claim datafile;
b) selecting items of property being claimed by consulting a property register configured and arranged to store items of property owned by the person or entity making a claim;
c) obtaining information to establish a replacement value for each of the items of property relating to the claim; and
d) selecting a method of settlement of the claim and calculating the replacement values for each of the items of property to determine a settlement value.

Preferably in step b) a further process is undertaken whereby an historical claims database is consulted to check the claims history of the claimant.

Desirably in step b) if any items being claimed match previous items claimed by consulting the historical claims database, a flag is generated to provide an indication to a user that further investigation may be warranted.

Advantageously the property register is periodically updated to ensure accuracy of the items of property. Preferably the property register is configured and arranged to be accessible by authorised third parties over a communications network. Desirably the steps of the method are carried out by a website server configured and arranged to allow access by authorised users.

Preferably the method further includes an archiving step wherein the datafile associated with a settled claim is moved to an archiving database wherein further changes to the datafile are not permitted.

Preferably the method further includes a post archiving revision step wherein the datafile associated with a settled claim is accessed from an archive location and reviewed and altered as required, and wherein an audit trail of the process is recorded.

According to a second broad aspect of the invention there is provided a computer controlled method for managing an insurance claim, the computer being programmed to carry out the steps of:
A. generating a claim datafile by receiving information relating to a claim, including items of property relating to the claim;
B. selecting items of property being claimed by consulting a property register configured and arranged to store items of property owned by the person or entity making a claim;
C. obtaining information to establish a replacement value for each of the items of property relating to the claim; and
D. selecting a method of settlement of the claim and calculating the replacement values for each of the items of property to determine a settlement value.

Desirably in step B. an historical claims database is consulted to check the claims history of the claimant, and if any items being claimed match previous items claimed the claimant, a flag is generated to provide an indication to a user that further investigation may be warranted.

According to a third broad aspect of the invention there is provided a system of managing an insurance claim, the system including a property register configured and arranged to store items of property, the property register being configured and arranged to be updatable with current schedules of items of property, the database having means to accept a request to add or delete or update an item of property, and to allow access by authorised users to consult the items of property.

### BRIEF DESCRIPTION OF THE DRAWINGS

Preferred embodiments of the invention will now be illustrated, by way of example only, with reference to the accompanying drawings in which:

FIG. 1: Shows a system and method for processing a claim;

FIG. 2: Shows a flow chart of processing steps in the settlement of a claim; and

FIG. 3: Shows data flows between databases, registers and organisations in a system according to a preferred embodiment of the invention.

### DETAILED DESCRIPTION OF THE DRAWINGS

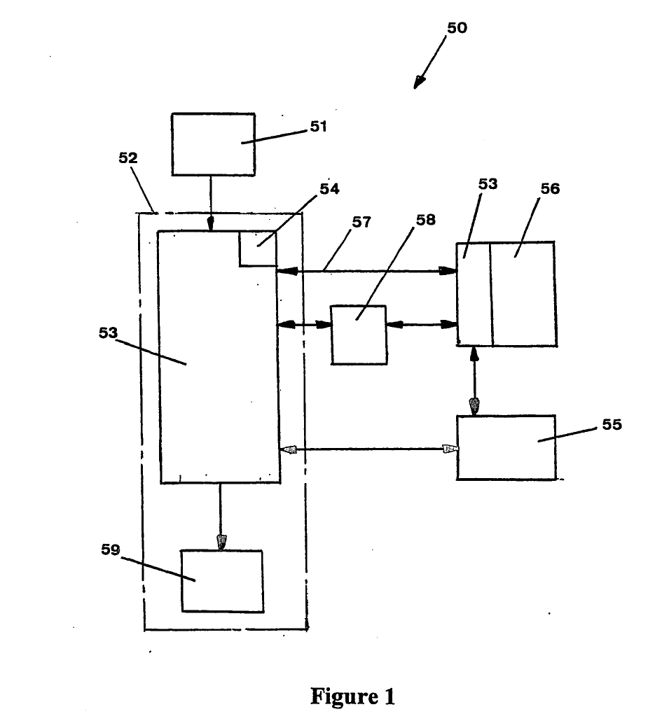

Referring to FIG. 1, a system for processing an insurance claim, generally referred to as 50, according to a broad aspect of the invention, is illustrated.

The embodiments of the invention described herein are with reference to insurance claims and for the management of items of property owned by respective persons or entities, although it will be appreciated that the various methods and systems employed are, inter alia, for determining the current value of an item of property, and for facilitating the settlement of claims. A description of systems and methods for the management of insurance claims is as expressed in Australian Patent Serial No. 769642 titled “Methods and Systems for Managing Insurance Claims” and such description is wholly incorporated herein as part of this description.

The claims that may be processed in accordance with any one or more aspects of the invention can include damage or loss to personal property, medical, travel, accident, income, life or house contents insurance or any other item of property or thing or person that can be covered by an insurance policy and later be made the subject of a claim under an insurance contract.

This method 50 involves at least one claims operator associated with an insurance company or organisation 52 who can receive details of the lodged claim 51 and create or load a new claim datafile by using a CAPS program 53. A new datafile can be created by allocating a reference number. Loadable information can include all relevant data such as, for example, the claimant's name and contact details, type of claim (i.e. loss through theft or burglary, or damage by accident), an event date being the date of the loss or damage to the item of property, insurance organisation and branch in the arrangement whereby outside parties may be reviewing and processing the claim datafile, policy type, policy excess if applicable, claim processing operator's name and title, and any other relevant information that may be useful or required with processing a claim.

When the data has been loaded into appropriate fields, the datafile is saved and stored in a claims database 54. It will be appreciated that further information on the items of property being claimed can be included in the data entered previously or as a separate step in the claim settling process. The claims data is desirably associated with a search engine that can allow users of the CAPS program 53 to search for a datafile by any field, or more desirably by the name of a claimant, claim reference number, and/or by policy number.

It will be appreciated that an operator or insurance agent can load information or data relating to a claim in a variety of ways. One common way is by inserting the appropriate data by keyboard into fields on a loading screen displayed on a computer monitor. The display screen can be windows-based to conveniently display the data entered before the data is saved.

The operator loads data on the item(s) of property being claimed. The item(s) description, date of purchase and purchase price, in an appropriate currency, is entered. A group code for a category of property may be selected. This is useful when large numbers of items are being claimed and sub totals of the groupings can be provided to claimants on settlement rather than a large itemisation of property. This information or data is also saved to a database 54.

Desirably the replacement value of any item is obtainable by sending a computer request command to a second database in the form of a replacement quote or price enquiry database 55 (“PED”). The PED 55 is consulted with a request and will respond by providing a value of the item requested. It will be appreciated various coding can be used to allow the CAPS 53 and PED 55 programs to communicate, and that standard suitable communication systems can be employed to allow the programs to exchange data. Common communications systems include local area networks, wide area networks, internet and cable links, radio frequency, telephone lines via modems, and/or a computer server hosting various databases and/or slave servers and the like, and communicating with client terminals by cable or abovementioned networks.

Information relating to some items can be obtained by a consultant 58 or third party such as an investigator, assessor or claims consultant. Details of the claim are viewable by the consultant 58 who determines the item value and provides such a value to the insurance organisation 52 or a separate claims management organisation 56 (“CMO”), as required. Such third parties can be provided with a CAPS computer program 53 or associated program to enable such parties to communicate directly by data exchange over the internet, a wide or local area network, or otherwise.

An item or items in a claim can then be settled by a variety of methods. These methods may include cash settlement, supply settlement, voucher settlement and market value settlement. Each item in a claim can be settled individually. It is envisaged that in some instances items can be settled in groups or categories.

It may well be that the adjustment made to the initial value of an item does not include a depreciation ratio if the item in a claim is settled by supply settlement or voucher settlement. This may be because the item is being replaced rather than a monetary figure paid. The CAPS program 53 can be customised to comply with a particular insurance organisation's settlement policies, and the particular obligations an insurance organisation is contracted under a policy to meet

With a cash settlement, the cash value is calculated for each item and the settlement amount is minus any excess that may apply to the final amount reimbursed. A print function 59 can be activated to print a settlement cheque or payment made directly into claimant's bank account.

With a supply settlement, a user can settle a claim by selecting a retailer or supplier of an item being claimed to supply a replacement item to the claimant. To select a supplier the CAPS program 53 may include a drop down box having a table to select a preferred supplier. It will be appreciated that different insurance organisations may have a preference for some suppliers over others and such tables can be customised. The CAPS program 53 may allow a user to update a list of suppliers by adding or deleting suppliers.

The CAPS program 53 may include a quote option for items being claimed. With this option an operator can select a supplier and the appropriate information on the claim can be exported to a word processing program or sub program of the CAPS program 53 and printed in a pre-formatted letter.

With the voucher settlement, items in a claim where the settlement amount may have been determined at the adjustment stage to derive a settlement amount or value on the item can then settle the claim by generating and sending a voucher to the claimant. The voucher may be redeemable at any suitable supplier or retailer selected by the insurance organisation or otherwise. The claimant can then take the voucher to suppliers that will accept the vouchers for items of property. Further, the documents relating to a voucher settlement can be generated and sent directly to a supplier without having to print such documents. It is envisaged that all transactions conducted according to the invention can be conducted electronically, with any forms and documents prepared in electronic form and communicated to various parties, as required.

The voucher is optionally derived by a user selecting the voucher option in the appropriate display screen. The user can then select a supplier and the appropriate information on the claim can be exported to a word processing program or sub program of the CAPS program 53 and printed in a pre-formatted letter. The letter will record all the appropriate details of the claim including the item(s) settlement amount(s) and the supplier(s) the claimant can approach with the voucher.

With market value settlement, the market value is what one would expect to pay for a similar item on the open market based on factors such as the age, condition and market demand of the item. That final figure may become the settlement amount or may be passed through another variable as required.

The next stage of the process can involve a claim adjustment step. This step in the claims settlement process is with adjusting the initial assessed replacement value of the item depending on factors, for example, as the type of policy covering the item being claimed, the age of the item and any applicable depreciation rates, and any other policy factors that determine the output value of this step in the process. The output value can be seen as the settlement value or amount of the item being claimed.

An operator at an insurance company or organisation 52 may handle this processing step or may desirably refer this processing step onto a CMO 56. If the CMO 56, a claims datafile can be exported via link 57 to the CMO 56.

The CMO 56 can then make an appropriate adjustment to a claim or item in a claim to determine the settlement value. The settlement value can be determined by a mathematical calculation. This mathematical calculation can desirably include a depreciation ratio that is supplied by the particular insurance organisation 52 responsible for setting a client's policy claim. The expected life expectancy of an item is a factor that may be included in the claim adjustment. The CAPS program 53 may allow a computer operator to adjust the depreciation ratio as required. Once the final figure is derived a print function can be used to provide the claimant with details of the item(s) being claimed and the settlement amount(s).

Advantageously the CAPS program 53 can include an interactive report function relied on to track progress with the claim and to record details of telephone calls and other correspondence and instructions relating to a datafile. It will be appreciated that in any organisation many operators may work in a claim at various stages, and it may well be the claim may be audited at any one stage of the claim settlement process or simply a supervisor desiring to check that the file is in order before it is further processed or is archived.

The interactive report function can operate with a separate display screen or window having fields to record details. The fields may include the claim reference, insurance organisation, operator's identifier, claimant's name, and type of claim, with a large field for inserting text. Once the details are inserted the report is saved, and can later be retrieved from the datafile by executing a function to open the display window showing inputted details.

An advantage with the interactive report function is that an operator or user of the CAPS program, being able to obtain the claim datafile, can see everything on datafile at any location without requiring a paper file. This is a very desirable feature as it can save time and effort by not needing to request a file, and having to delay or wait to receive it, before further work can be progressed on the file. It also is convenient if a claimant contacts an insurance organisation wishing to discuss a claim or to query a claim, and a claims handler or other staff member may be able to assist with details on the file as it is readily retrievable or available.

The CAPS program 53 can incorporate a reinstatement function that allows for a re-evaluation of reinstatement costs, after loss valuations for reinstatement claims either at full replacement or indemnity costs.

The datafile on a claim can be easily transferred or exported/imported to the CAPS program 53 as required. Further, the status of a datafile can be changed, for example, from open to closed, depending on an insurance organisation's archive policy. It may be desirable to move datafiles on closed claims from an active and current database to an archived database for convenience purposes.

A copy of an archived file may be subsequently retrieved, reviewed and altered as required, Any further alterations can be desirably tracked and recorded to provide an audit trail.

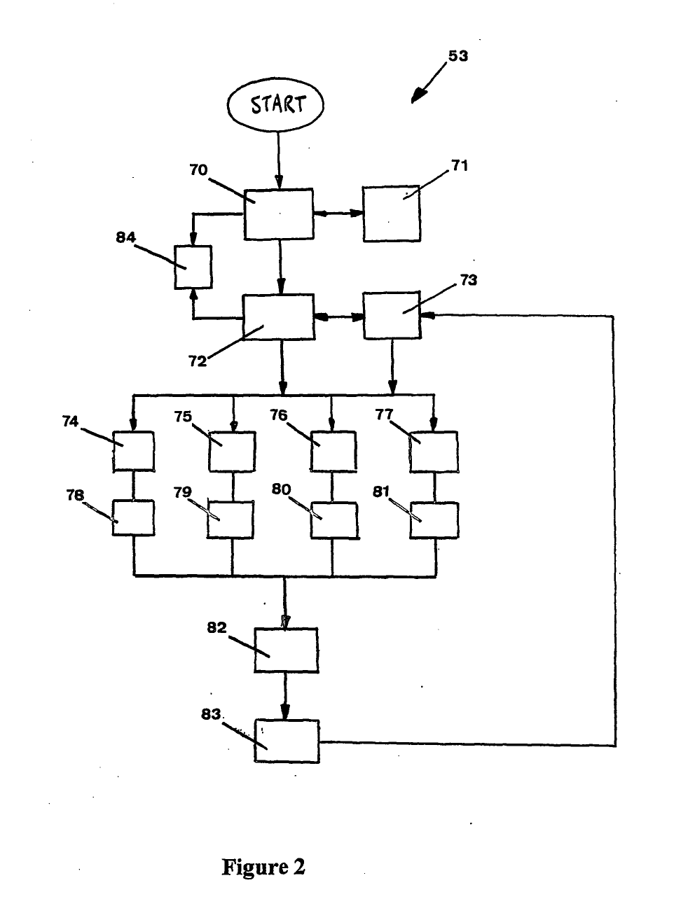

Referring to FIG. 2, a flow chart of processing steps in the settlement of a claim, is illustrated.

The CAPS program 53 functions to manage the various processing stages of handling or managing a claim to increase the likelihood of settlement of the claim reasonable quickly and efficiently, and with leaving an audit trail of transactions and correspondence at each stage of the workflow process.

A client lodges an insurance claim with an insurance organisation 52 and a claims handler will create a new claim datafile 70. Such lodgment can be via a website on the internet. The website can be configured to create the datafile 70 from the information supplied by the claimant and as prompted by the website. The program 53 may function such that the datafile 70 can not be saved to a current claims database until all the necessary data or information is entered in the various fields in the claim loading display screen. The program 53 can include prompts and help files to assist a claims handler or claimant to obtain and enter all the required data or information.

The claim datafile 70 is also generally associated with a current policy and policy details, relating to the items of property being claimed, can be imported or copied from a policy database 71 into the claims datafile 70, or a database reference or link can be saved as part of the database file.

If gaps in the information required for settling a claim is evident, such as the current replacement value of an item, then the program step 72 of obtaining such information is actioned. The action can be by way of querying a PED database 73 to obtain a value or quote of an item being claimed. The database 73, upon receiving the request, can process the request and provide a value to the program 53 of the item of property in question. When that item value is received, it can be loaded into the appropriate field in the datafile 70.

The program 53 allows for manual inputting of the value sought. This may be for a claim involving vehicle damage whereby a claims assessor must inspect the damage caused and to obtain a value of the damage to the vehicle and pass that onto the claims handler. It is envisaged that any outside third party may be provided with part or all of the CAPS program 53 to enable those parties to manage part of the claim electronically rather than via telephone calls and further manual input by a claims handler at the insurance organisation. That is, the claims handler can send a data request for information or values from, say, an assessor, sent by email or via a computer network to another computer loaded with the program 53 and allowing full access to the datafile 70, and the assessor will receive and action the request, and provide the information to the claims handler for inclusion in the datafile 70.

Once the required information on a claim is received, the next processing step is with adjusting the item value. A method of settling the claim or items in a claim is selected. It could be by cash settlement 74, supply settlement 75, voucher settlement 76 and/or market value settlement 77 or a combination of these methods, or otherwise, such as, for example, an agreed value between claimant and insurance organisation. Details of these methods of settlement are as described with reference to FIG. 1. Each item in a claim can be settled individually by any suitable method. It is envisaged that in some instances groups or categories of items can be settled together.

Once the settlement figure is determined, the next processing step can desirably include a printing processing step 78. This step is to assist with the final stage of the claims process and is convenient as all the relevant data relating to a claim can be easily exported to pre-formatted letters and reports and memorandums or otherwise rather than a claims handler re-entering such data in a word processing program.

With supply settlement 75, a user can activate a pop up window of a table and select, or enter details of, a retailer or supplier of an item being claimed to supply a replacement item to the claimant and/or services. The services may include an authorisation of a reinstatement company or repairer proceeding with work in order to properly indemnify the claimant. It will be appreciated that different insurance organisations, or even different branches of an organisation, may have preferences for some suppliers over others and such tables can be customised. The CAPS program 53 may allow a claims handler or any authorised person, to update a list of suppliers by, for example, adding or deleting suppliers.

The CAPS program 53 can include a quote option for items being claimed. With this option an operator can select a supplier and the appropriate information on the claim can be exported to a word processing program or sub program of the CAPS program 53 and printed in a pre-formatted letter in accordance with the supply settlement printing step 79. Suppliers include authorised repairers and reinstatement companies.

Alternatively the claims operator may choose to activate a sub-routine in the program 53 to directly order a replacement item to be delivered to the claimant from the supplier. Advantageously this order is placed digitally and may be communicated to the supplier having a CAPS program 53 or a part thereof of the program tailored to meet this direct ordering processing step. An advantage with this method is that it avoids printing an order form and sending by postal mail.

With the voucher settlement 76, items in a claim where the settlement amount may be determined by the purchase price of the item in the case where the item is covered by a replacement value in the relevant policy. The program 53 can then be used to settle the claim by generating and printing a voucher for the claimant in accordance with a printing step 80. The claimant can then take the voucher to specified suppliers that will accept the vouchers for items of property.

The voucher can be generated by a program user selecting the voucher option in the appropriate display screen. The user can then select a supplier and the appropriate information on the claim can be exported to a word processing program or sub program of the CAPS program 53 and printed in a pre-formatted letter. The letter will record all the appropriate details of the claim including the item(s) settlement amount(s) and the supplier(s) the claimant can approach with the voucher.

With market value settlement 77, the market value is what one would expect to pay for a similar item on the open market based on factors such as, including age, condition and market demand of the item. Such a value may be obtained by consulting the PED 73. That final figure may become the settlement amount or may be passed through another variable as required. Further details are as applied to market value settlement as described with reference to FIG. 1. Other mathematical calculations may be applied and values and figures insertable in fields on the display screen can be adjusted as required. That final figure may become the settlement amount or can be manually changed, if required.

Once the final settlement amount of the item is derived a printing step 81 function can be used to provide the claimant with details of the item(s) being claimed and the settlement amount(s) in a pre-formatted letter or table.

A print function 82 may be activated after any one of steps 78 to 81 are completed to print a settlement cheque. It is envisaged that if the claimant's bank account details are available a direct debit facility may be set up for payment.

When the claim has been completely actioned and any auditing of the datafile has been made, then the insurance organisation may direct that the claim be closed. At this stage the archive step can be actioned by the program by moving the current claims datafile from the database 73 to an archive database 83.

The archive processing step involves freezing the datafile 70 and therefore no changes to any data can be subsequently made. Additionally, at any stage of the claim management process, an operator can activate a pop up display window and enter a report 84. This is to allow tracking of activities on a datafile 70 and recording of correspondences.

The CAPS program 53 can function to allow for a multitude of variables reflecting the myriad of claims management and settlement options available. That is why, for example, the settlement amounts or figures can be manually over ridden by an authorised claims handler who must exercise an appropriate level of judgement when settling claims.

It is envisaged that the program 53 can be easily adapted to include search and report functions, with printing options, involving a current working database and/or the closed archive database 84. The statistical analysis may desirably include reports such as the number of claims from a geographical location or certain demographic factor, claimant, claim types and yearly claim figures. Such reports are only limited by the fields in the program and the amount of information obtained from claimants or otherwise, and entered into datafiles.

An advantage with the CAPS program 53 is that it is configured and functions to allow a particular insurance organisation to easily and conveniently export and import claim datafiles and interact with third parties outside the organisation or staff located at another branch of the organisation. The reliance on paper files can be avoided as all the file documentation or information can be readily available from a datafile viewable at any terminal or computer programmed with the CAPS program 53. Datafiles can be conveniently compressed and exported as an email attachment via the internet or by any other form of communication means, or simply transferred physically via suitable media

It is envisaged that when international currencies are involved with determining insurance claims, for example with a claim under travel insurance, the CAPS program 53 may include a feature having direct access to currency conversions, whether current or historic currency data, and may also include replacement quote values for foreign countries.

The CAPS program 53 can include a user's operating manual in the form of help files that can be dropped from the tool bar of a display window.

Referring particularly to FIGS. 1 and 2, it is seen that in various embodiments of the invention a replacement quote database, or more accurately termed, a Price Enquiry Database (“PED”) has been consulted in the claim settlement process.

The PED includes current replacement values, market values and historic values of items. The PED has the advantage of being programmed and configured to provide current values for items of property being claimed. As PED can desirably be used in association with the CAPS program 53, and as PED can be consulted digitally, it is seen that a claims handler using the CAPS program 53 can settle a claim reasonably quickly by obtaining a reply to a request within a short time period.

The PED can be kept current with item values by an associated program set up to get information from various sources as required. The PED can be configured with a linked network of third parties that are consulted in the case of an unusual item not being present in the PED database. In this situation an assessor or valuer at a remote location can be provided with a program (not shown) that interacts and communicates with the PED and/or PED software program.

The assessor or valuer can obtain the replacement value of the item requested and sends it, desirably electronically, to the PED that immediately updates its database and actions a reply to the initial request for the replacement value. If the replacement value of that item is again requested at a later date by any insurance organisation or operator using a CAPS program 53, the PED can send the value immediately after locating it in its database.

The information that may be detailed in the PED include a category of item, a description of the item, the replacement value, a supplier of the item, and the date the database was updated with the replacement value of the item. It will be appreciated that the computer program associated with the PED may include a searching function for items, a log of activities with time stamps, and any other known associated feature with a software program that can enhance its capabilities.

It is envisaged that the CAPS program 53 can function in conjunction with the PED to form a complete package. This package can optionally be operational at any one location, particularly in the case of smaller applications of the program.

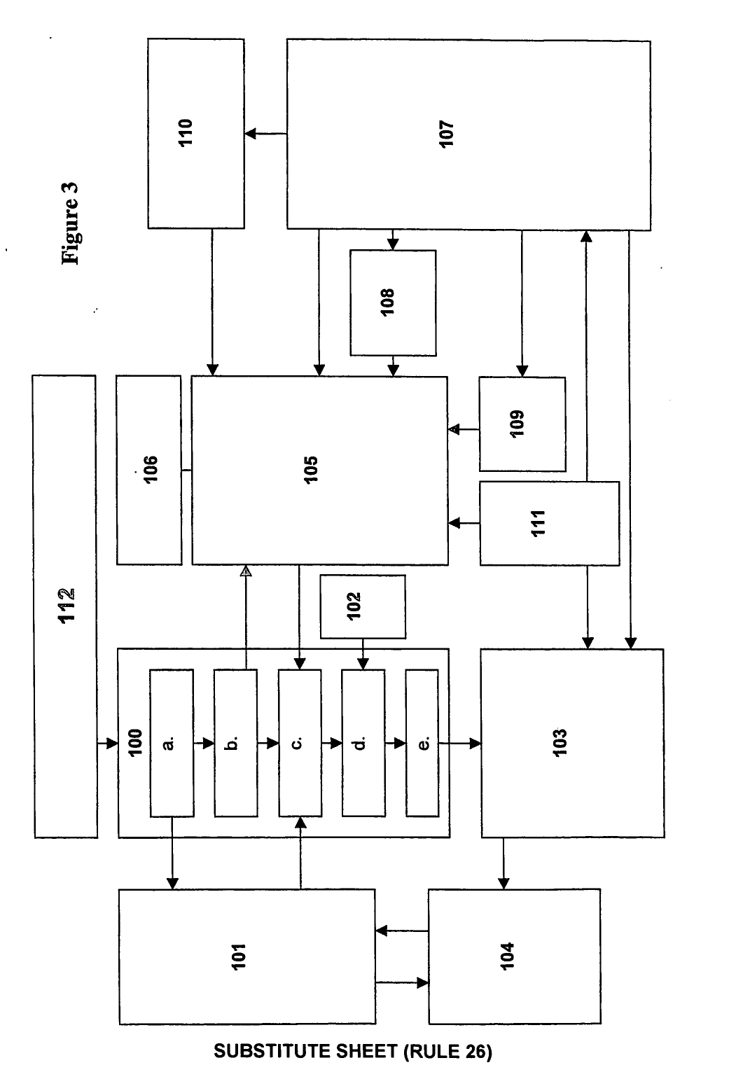

Referring now to FIG. 3, a block diagram of data flows between databases, registers and a selection of some relevant organisations, is illustrated.

The processing steps of a CAPS program 100 is similar as already described with the CAPS program with reference to FIGS. 1 and 2 and need not be repeated in detail. However, a broad summary of the processing steps as seen by steps a. to e. in FIG. 3 are described as follows. The first step a. is with generating a claim datafile by receiving information relating to a claim, including items of property relating to the claim; then step b. is proceeded with by selecting items of property being claimed by consulting a property register configured and arranged to store items of property owned by the person or entity making a claim; then step c. is commenced with obtaining information to establish a replacement value for each of the items of property relating to the claim; and finally step d. is with selecting a method of settlement of the claim and calculating the replacement values for each of the items of property to determine a settlement value. The optional and non-essential final step e. in the process with settlement of the claim with the claimant by the step of actioning settlement, electronic means and/or manually, by printing out vouchers or a settlement cheque or otherwise, and optionally generating the documents for confirming settlement.

It is considered that when a claim is being processed according to the CAPS program 100, one of the steps will include consulting an historical claims database 101 to check the claims history of the claimant. The check may include determining whether the claimant has made a previous claim with any insurance organisation and/or to determine whether any one or more items being claimed have been previously claimed. This check has the advantage of assisting an investigation into whether a claimant may be fraudulently making a claim, or at least can raise a flag or sign to direct further investigation of the claim and the claimant should that be considered prudent.

The process may be carried out by forming a link via an insurance organisation 103 to an insurance claims register 104. The insurance claims register 104 may be a commonly linked register 104 from a plurality of insurance organisations (not shown) and/or including any other users of the CAPS program 100 that manages insurance claims or any other interested party such as an agent for any insurance organisation or claims management organisation 112.

Alternatively, it is envisaged that the insurance claims register 104 may be incorporated in the processing steps of the CAPS program 100 and can be located on a server within one organisation rather than being located externally via an external link or wide area network to a claims register 104. Further, the insurance claims register 104 may be consulted by other parties, as required and subject to any applicable laws regarding the handling of personal information.

A Price Enquiry Database 102 (referred to hereinafter as “PED”) may desirably be consulted in a claim settlement process. As detailed with reference to FIGS. 1 and 2, the PED 102 can include current replacement values, market values and historic values of items of property. The PED 102 has the advantage of being programmed and configured to provide current values for items of property being claimed. As the PED 102 can desirably be used in association with the CAPS program 100, the PED 102 can be consulted as required.

The PED 102 can advantageously be kept current with item values by an associated program set up to get information from suitable sources to ensure the accuracy of listed values of items of property. The PED 102 can be configured with a linked network of third parties that are consulted in the case of an unusual item not being present in the PED 102. In this situation an assessor or valuer at a remote location can be provided with a program (not shown) that communicates with the PED 102 and/or PED software program and associated server.

The claims management method and system can also preferably include the creation, update and consultation of a personal property register or database 105 configured and arranged to store a plurality of details of personal property. That is, for each client and potential claimant, all the personal property that may be covered by a possible claim at a future date, or for any other desirable reason such as, for example, property the subject of a deceased client's estate, may be stored electronically in any suitable format.

The date or information being held by the personal property register or database 105 may be in any form, and can desirably include images in any format such as, for example, JPEG or TIF or otherwise. Such images of items of property or of any item of value to a client 107 can be stored in a secondary database 106 or be incorporated in the personal property database 105. Such images can be uploadable to the personal property database 105 by the client 107 or the client's agent 108 from time to time, and be downloadable or viewable by an insurance organisation at the time of a claim or for any other purpose.

The personal property database 105 may also include a facility to store scanned documents proving ownership of property, and other documents such as valuations, guarantees, serial number cards, and legal documents being stored elsewhere. It will be appreciated that the secondary database 106 can store some of these further details.

To obtain such photos or digital images a client 107 or agent 108 may initially set up an inventory of images, and then periodically update the inventory. A client 107 or agent 108 may make an inventory of all items of property. This form of inventory can desirably include private collections of any property of worth and value the subject of an insurance cover such as, for example only, stamps, coins, artworks, jewellery, antiques, and the like. By documenting such collections and loading lists of such collections, a client, and any relevant authorities, would have easy and quick access to such inventories and collections for purposes other than settling an insurance claim, such as, for example, a revision of values, re-appraising the worth of collections, for sales purposes at auctions, or otherwise. However, the main purpose may be for the reason of making an insurance claim quickly and easily when a collection or property has been lost or stolen and is the subject of an insurance claim.

Only authorised access to the inventories and the personal property database 105 may be applied, and access is also envisaged as being allowable remotely via the internet or by any suitable communication means. A client 107, or a client's agent 108, can have access to the personal property database 105 to update the inventory of property, and such updates are envisaged as being useful to ensure accuracy of the inventories should a claim or related consultation be made.

The formatting of the inventories may be in any suitable form, and may desirably be in a form to allow for ease of additions and deletions, and general updates. Further, the format may preferably be such that importing and exporting functionality is achieved. Further, the categories applied to the inventories of clients may be by type or value, by collection, by policy benefit, chronologically by age of each item, or by any other desirable type.

One advantage of the personal property database 105 is that it should increase the promptness of settlement of a claim.

It is envisaged that clients may customise their personal register by selecting the insurance organisation 103 they are insured with, enter an appropriate customer identification number, and provide information relating to a particular insurance policy, thus shifting items into appropriate insurance policies as required.

The personal property database 105 may be configured and arranged to automatically update the sum insured of the items of property being covered by a policy, and such update could be exported to the relevant insurance company covering the property. The client and any other interested parties may also be automatically notified electronically via the internet or the like, of any changes of policy or with information affecting a policy covering property being listed on the personal property register or database 105. Any premium changes, including regular policies, can be desirably sent electronically to the client 107.

It is seen that the personal property database 105 may be utilised for moving or storage quotation purposes. Downloaded items of property can be viewable when running the CAPS program 100 that may be, for example, on an agent's laptop computer or by a shipping company 109 computer. It is envisaged that information flows between various organisations in FIG. 4 can be achieved for any desirable purpose with the inventories loaded on the personal property database 105.

The personal property database 105 can be consulted by government agencies 110 such as the Police and/or Public Trust. In the case of the Police, items of property claimed as stolen can be forwarded to the Police as required. The Public Trust organisation or other such estate management organisation can desirably use the inventories to assist in the assessment and valuation of estate property. This consultation process may advantageously save time by the creation of an accurate inventory that indicates when property was owned or in trust by the client 107.

Additionally, a retailer 111 may, at the point of sale with a client 107 present, or at any other suitable or convenient time, could ask the client 107 if they have a personal property inventory in the system as being described, and if so, the retailer 111 could forward information on a sale and/or update the client's property register or inventory with the item or items of property being purchased. This transaction could be in the form of a datafile update request being forwarded to the personal property database 105, and actioned accordingly. A copy of the update of the client's property inventory can then be sent to the client 107 and/or the insurance organisation 103.

The personal property database 105 may further include a response unit (not shown) that enables a client 107 to communicate with the insurance organisation 103 at the time the client 107 enters information into the system. In this respect, the insurance organisation 103 or a group of member organisations 103 can potentially be in contact with the client 107 and service various insurance requirements of the client 107.

It is envisaged that the personal property database 105 can be utilised at any time by any client 107 for a variety of purposes, not just to update the personal property inventory. The easy flow of information and communications between all parties involved in either a claim settlement transaction, or in the insurance business, can be networked, and provided with suitable computer software programs so as to participate in the systems and methods of the invention.

The use of a website or series of linked websites, and the current use of the internet make this system not only viable but very practicable and efficient to all parties involved in the settlement of insurance claims, and other business activities associated with insurance contracts, policies and the like. It is considered within the scope of the invention to provide the CAPS program 100 and associated registers and databases on a computer server or suitably networked servers configured and arranged to allow access by users who do not require any software for consulting purposes, but simply authorised access to the computer server via any known communications means including a local or wide area network or via the internet.

Wherein the aforegoing reference has been made to integers or components having known equivalents, then such equivalents are herein incorporated as if individually set forth. Accordingly, it will be appreciated that changes may be made to the above described embodiments of the invention without departing from the principles taught herein.

Additional advantages of the present invention will become apparent for those skilled in the art after considering the principles in particular form as discussed and illustrated. Thus, it will be understood that the invention is not limited to the particular embodiments described or illustrated, but is intended to cover all alterations or modifications which are within the scope of the appended claims.

1. A method of managing an insurance claim, the method including the steps of:
a.) obtaining information on a claim, including items of property relating to said claim, such information forming a claim datafile;
b.) selecting items of property being claimed by consulting a property register configured and arranged to store items of property owned by the person or entity making a claim;
c.) obtaining information to establish a replacement value for each of the items of property relating to the claim; and
d.) selecting a method of settlement of the claim and calculating the replacement values for each of the items of property to determine a settlement value.

2. A method according to claim 1 wherein in step b. a further process is undertaken whereby an historical claims database is consulted to check the claims history of the claimant.

3. A method according to claim 2 wherein in step b. if any items being claimed match previous items claimed by consulting the historical claims database, a flag is generated to provide an indication to a user that further investigation may be warranted.

4. A method according to claim 1 wherein the property register is periodically updated to ensure accuracy of the items of property.

5. A method according to claim 1 wherein the property register is configured and arranged to be accessible by authorised third parties over a communications network.

6. A method according to claim 1 wherein the steps of the method are carried out by a website server configured and arranged to allow access by authorised users.

7. A method according to claim 1 further including an archiving step wherein the datafile associated with a settled claim is moved to an archiving database wherein further changes to the datafile are not permitted.

8. A method according to claim 1 further including a post archiving revision step wherein the datafile associated with a settled claim is accessed from an archive location and reviewed and altered as required, and wherein an audit trail of the process is recorded.

9. A computer controlled method for managing an insurance claim, the computer being programmed to carry out the steps of:
a. generating a claim datafile by receiving information relating to a claim, including items of property relating to the claim;
b. selecting items of property being claimed by consulting a property register configured and arranged to store items of property owned by the person or entity making a claim;
c. obtaining information to establish a replacement value for each of the items of property relating to the claim; and
d. selecting a method of settlement of the claim and calculating the replacement values for each of the items of property to determine a settlement value.

10. A computer controlled method according to claim 9 wherein in step b. an historical claims database is consulted to check the claims history of the claimant, and if any items being claimed match previous items claimed the claimant, a flag is generated to provide an indication to a user that further investigation may be warranted.

11. A computer programmed to carry out the processing steps of either claim 9 or claim 10.

12. A system of managing an insurance claim, the system including a property register configured and arranged to store items of property, the property register being configured and arranged to be updatable with current schedules of items of property, the database having means to accept a request to add or delete or update an item of property, and to allow access by authorised users to consult the items of property.

13. A method according to claim 1 substantially as herein described.

14. A computer controlled method according to claim 9 substantially as herein described.

15. A system of managing an insurance claim substantially as herein described with reference to any one of the accompanying drawings.
